(19) United States
(12) Patent Application Publication
(10) Pub. No.: US 2004/0010466 A1
(43) Pub. Date: Jan. 15, 2004

(54) Financial instrument system providing multiple transaction information reporting and storing options and fraud and warranty protection

(76) Inventor: David F. Anderson, Nevada, IA (US)

Correspondence Address: PORTER WRIGHT MORRIS & ARTHUR, LLP, INTELLECTUAL PROPERTY GROUP, 41 SOUTH HIGH STREET, 28TH FLOOR, COLUMBUS, OH, 43215

(21) Appl. No.: 10/193,517

(22) Filed: Jul. 11, 2002

(51) Int. Cl. G06F 17/60

(52) U.S. Cl. 705/45

(57) ABSTRACT

A universal system to provide manual and automated income and expense records to a user or provider of services using indicia linked to categories contained in a financial instrument. Indicia may be multiple forms of display, such as image and numerical, for category reports prepared in conjunction with an account. Categories may be pre-designated, individual, or personally designated. Record-keeping of category expenditures and income may be manual or automated. The financial instrument may be physical or electronic and storage of transactions may be physical or electronic. The automated embodiment of the system uses character recognition software for the identification of written indicia. The system includes several forms of protection, including warranty and fraud protection.

### RELATED APPLICATIONS

This application is related as a continuation-in-part to application for design patent for Financial Instrument filed on Oct. 2, 2001, Ser. No. 29/149,095. This application is commonly owned by the assignee of the application Ser. No. 624,741, filed Mar. 21, 1967, considered by the Supreme Court of the United States in the case Dann v. Johnston, October Term, 1975, No. 74-1033, Dann v. Johnston, 425 U.S. 219 (1976). Both applications are incorporated herein by reference as if set out in full.

### FIELD OF THE INVENTION

The present invention relates to a financial instrument product and system that combines several unique and useful functions for financial instruments, such as printed bank checks and deposit slips as well as electronic transactions, to offer the user, in addition to all features of an accounting of a transaction, several forms of record-keeping options, both manual and automated; several forms of security for the instruments in the form of fraud and warranty protection; and a variety of information reporting and storing options for later reference.

### BACKGROUND AND SUMMARY OF THE INVENTION

An object of the invention is to provide complementary value added multiple features in a single financial instrument; namely, manual record-keeping, automated record-keeping, character recognition protocols, electronic payment, and fraud and warranty protection. In a paper version of the invention, the system software recognizes the presence or absence of an indicia on an image of a scanned instrument, such as a code number; uses character recognition software to identify a category; adds snippets of the payee, date and/or “For” line description; and allows fraud protection and warranty programs. All of these fields are uniquely incorporated on a single instrument in a system that allows a variety of information reporting and storing options for future reference by the user or account provider.

The improved system combines manual and automated record-keeping services to provide income and expense records using, for example, printed bank checks and deposits. The system is offered through banks and other financial institutions. The unique check design of aforementioned application Ser. No. 29/149,095 allows a choice of record-keeping methods, either manual or automated. The unique check has both a bar for a predetermined code based on letters, symbols or numbers, (for example, one through twelve, however the number of codes is not limited) used in a manual system, and a box to designate a one, two or three digit number (or letter or symbol) used in an automated system.

In one embodiment, the user may elect the manual system that uses a series of twelve boxes on the check and deposit, positively designated at the time the check or deposit is written. This classification of income and expense identifies the category so the checks or deposits can be filed by the user according to the category of income or expense marked. Or, the code number could be noted on the duplicate copy of the check or deposit or entered in the check register if the checks and deposits are truncated (not returned).

In the same example, the check, in addition to the manual version box (marked one through twelve), there is also a one, two or three area space for indicating a code category for use in the automated version of the system. The user first indicates to the financial institution that he wants to use the system. The mere choice of an instrument that uses the system may also give the financial institution indication of a user's use of the system. The user defines his chart of accounts by assigning a number (or letter string) to different income and expense categories, or by selecting one of the predetermined category code lists. Should the user so choose, the financial institution can print a category code card that the user can carry in or adhere to his checkbook or check register.

To use one version of the automated form of the system, the user simply writes the code number (or letter(s)) in the space on the checks and deposits as they are written. The financial institution or processing center creates an image of the instrument, which, through the use of the system software, scans each check and deposit image to first determine whether a mark was written in the space. If the software detects a mark, the character recognition software contained in the system software attempts to interpret the mark as a number and/or letter. The software, through a series of algorithms, reads the one, two or three number/letter/symbol string and assigns a value to each. The software could reside at the financial institution, processing center, or on a company owned or licensed server, which would be accessed, such as via the Internet, by the financial institution or the end user, such as a customer. If the check is truncated at point of sale or point of purchase, the expense code information is captured automatically and converted to an electronic transaction. If the software is unable to recognize a number or letter within the prescribed criterion, that is, if any of the one, two or three number/letter/symbol are not assigned a value within the percentage of accuracy as defined by the operating bank, other financial institution or data processing center, the recognition software will send a signal to the system program, and the image of the check or deposit will be assigned for visual review, such as by a clerk at a computer work station, to determine the appropriate code string.

In another version of the automated form of the invention, the system incorporates the capability to register, store and report non-check transactions. In the case of a transaction being initiated with a non-check instrument, such as a debit or credit card, the electronic transaction record contains the name and location of the originating transaction reader. A code, such as one used by the U.S. Standard Industrial Classification (SIC) system, may be used to determine the classification of the merchant or point of sale, which would then be used to generate an appropriate category designation on the user report.

As an example of this embodiment, the use of a form of an electronic payment mechanism, such as a debit card, a “Speedpass” [a trade mark/service mark of ExxonMobil Oil Corporation, Irving, Tex.] transponder linked to a credit or debit card, and the like, for a transaction originating at a gas station could be globally “mapped” such that all transactions associated with that gas station ID number are classified as being an “Auto” expense in the system. Alternatively, the system allows individual users to designate specific expense or income codes for a particular merchant ID, such as a user designating all expense electronic transactions from a pharmacy as “Prescription Drugs.”

The financial instrument also incorporates several forms of protection. Fraud protection is provided by first recording the user's account number and a number associated with the particular instrument in a database. Repayment is provided to the user for any lost, stolen or fraudulently used instruments. Fraud is one of the major concerns of the check processing industry. Additional warranty protection may be provided on any items purchased and paid for with the instruments of the system. The design of application Serial Number 29/149,095 defines the preferred embodiment of a dual purpose check to be used by financial institutions and their customers.

The invention also employs character recognition software. Several versions of recognition software are available; however applicant prefers a program supplied by Orbograph USA, 44 Manning Road, Billerica, Mass. 01821. The system may incorporate other types of character recognition software. The version or brand of recognition software does not change the purpose of, or the operation of, the system.

The invention is described more fully in the following description, including the preferred embodiment, considered in view of the drawings in which:

### BRIEF DESCRIPTION OF THE DRAWINGS

FIG. 1A is a front view of the check or other form of financial instrument in accordance with the invention.

FIG. 1A1 shows an alternative embodiment of the check code area.

FIG. 1B shows a deposit slip of the invention.

FIG. 1C shows the duplicate check system of the invention.

FIG. 1D shows indicia representing a category being marked by a user.

FIG. 1E shows indicia representing a category being marked by a user.

FIG. 2A depicts a representative category code chart of accounts.

FIG. 2B depicts a representative category code chart of accounts used in an electronic version of the invention.

FIG. 3 depicts a check register record associated with a particular account showing codes associated with the account.

FIG. 4 is a flow diagram showing the expense and income record flow and report creation process of the invention.

FIG. 5 is a schematic diagram depicting the system structure and interrelationship with the payment system.

FIG. 6 is a depiction of the report, such as a statement, generated by the system.

### DETAILED DESCRIPTION

The present invention relates to expense and income coding services offered through banks, brokers, credit unions, and other financial institutions. Although these services have been around for many years, the unique incorporation of manual and automated services through one design of universal applicability, with several forms of protection, and incorporation of character recognition software for the identification of code numbers, improves the value of the transaction account. As these transactions are imaged, either at the point of sale or at another point in the clearing process, the automated processing of the instrument advances the state of the art, improves the processing efficiency, reduces the cost of processing, and reduces the time involved in processing. The system may be accessed in a variety of ways, including but not limited to, the Internet, telephone and other transmittal methods. Such methods of access should reduce the costs to deliver the service to the end user and add convenience and utility in the maintenance of an account.

Experience has proven that individuals fail to complete account record-keeping tasks for a variety of reasons: the amount of work required on a manual basis; the “double” entry of data needed to accomplish the job, whether done manually or through the many systems available that require the user to submit information on separate forms; or the complexity of Personal Financial Software (“PFS”) systems, such as “Quicken®” or “Quickbooks®” (trademarks of Intuit of Menlo Park, Calif.), or Microsoft “Money” (a trademark of Microsoft Corporation of Redmond, Wash.).

Since the mid 1960's, REC-CHEK, Inc. of Nevada, Iowa has made various versions of its proprietary REC-CHEK® (a trademark of REC-CHEK, Inc. of Nevada, Iowa) software available to banks, credit unions, brokers, individuals and businesses. This software allows the user to write a one, two or three number/letter/symbol string in a space on each check and deposit at the time the check or deposit is written. REC-CHEK® software is utilized by users such as a financial institution or an end user. Information is entered and stored, allowing periodic reports showing income and expense in a variety of formats, and either paper or electronic delivery. The information can also be downloaded into other PFS systems, like Intuit's Quicken.®

The software may be housed at a financial institution, processing center, or on a company owned or licensed server, which would be accessed by the financial institution or the end user. When the software is operated by the client's financial institution or other facility, such as a processing center, the resulting financial reports are automatically sent to the user, requiring little extra effort by the user. Under previous systems, the financial institution, however, experienced higher operating costs associated with a workstation operator reviewing each check and deposit. The operating costs, plus a markup by the financial institution, sometimes priced the service out of the price range of the average user. The present invention lowers the cost of providing record-keeping and fraud and warranty services, providing a product that is more affordable and available to more users.

The invention can be used by employing simple to complex technical requirements, and has the advantage of being affordable to those who cannot afford a costly system. The manual record-keeping system allows the user to simply mark through an indicia (in the preferred embodiment, one of the numbers (one through twelve) or letters on the bar at the left side of the check and/or deposit slip) to represent an income or expense category. The user can choose one of the predetermined category lists or devise his own. The code number/letter(s) marked on the check or deposit is then recorded on the check register, or the check is filed in a check file box, using dividers corresponding to the indicia (in the preferred embodiment, the dividers are numbered one through twelve) for the representative categories corresponding to the codes. The manual system allows utmost privacy, as the category list need not be known by any outside party. The different account types with which the universal instrument and system of the invention may be used include accounts in which instruments are truncated and accounts in which instruments are returned to the account holder.

The system for providing multiple reporting and storing options for deposit and expense information designated by financial instruments linked to a predetermined account type includes an instrument capable of bearing financial information linked to the account, the instrument including separate fields for 1) an array of one or more than one indicator in which an indicia corresponding to a predetermined financial category, selected from a designated transaction type related to a group of payee and deposit categories; can be applied; 2) the designation of an amount of a particular transaction; 3) a date; 4) memo information related to the particular transaction, 5) at least one of payee and depository institution identification; and 6) MICR account identification information.

The instrument is processed in a system in which the indicia corresponding to a predetermined financial category selected from a designated transaction type related to a group of payee and deposit categories is identified. The system, in either a manual or automated version, 1) determines which indicator within a given array has an indicia applied; 2) links the information concerning the applied indicia to other fields of the financial instrument; 3) sorts information derived from the fields based on the predetermined income and expense category linked to the number/letter(s); 4) links the financial instrument to information concerning financial debits and credits to and from the account associated with one or more than one category of the transaction and a payment or credit to or from the provider of the account; 5) collates the information from the sorted fields into one or more than one data record associated with a predetermined category; 6) generates a report associated with one or more than one predetermined account comprising a display of the collated information, and 7) makes the report available. The array of one or more than one indicator may be selected from the group consisting of a block of numbers or letters or symbols or foreign language characters (the manual version), and one or more blank areas (the automated version); the array may be a block of consecutive integers, letters, or symbols, or foreign language characters, or may comprise a blank area capable of accepting an OCR recognizable writing. Fraud protection indicia may link the financial instrument to an insurer and warranty protection for purchases by a user in a transaction in an account using an instrument of the system may also be included. The physical embodiment of the instrument may be truncated at a predetermined point in the payment or settlement process.

In the preferred embodiment (using the patent pending check and deposit), in addition to the bar listing numbers one through twelve, there is an area where the user can enter a one, two or three number/letter/symbol/foreign language character string, representing an income or expense category. By notifying the user's financial institution of the user's intent to use the “automated” version of the system (a financial institution may be notified automatically merely by the choice of the instrument defining the system), the user's account will be flagged, and all items will be read by software.

In addition to warranty and fraud protection, the options provided to the account include pre-designation of categories and codes, individual or personal designation of categories and codes, manual and automated accounting of category expenditures and income, physical and electronic storage of the financial instruments, and multiple forms of display, such as image and numerical, for reports prepared in conjunction with the account.

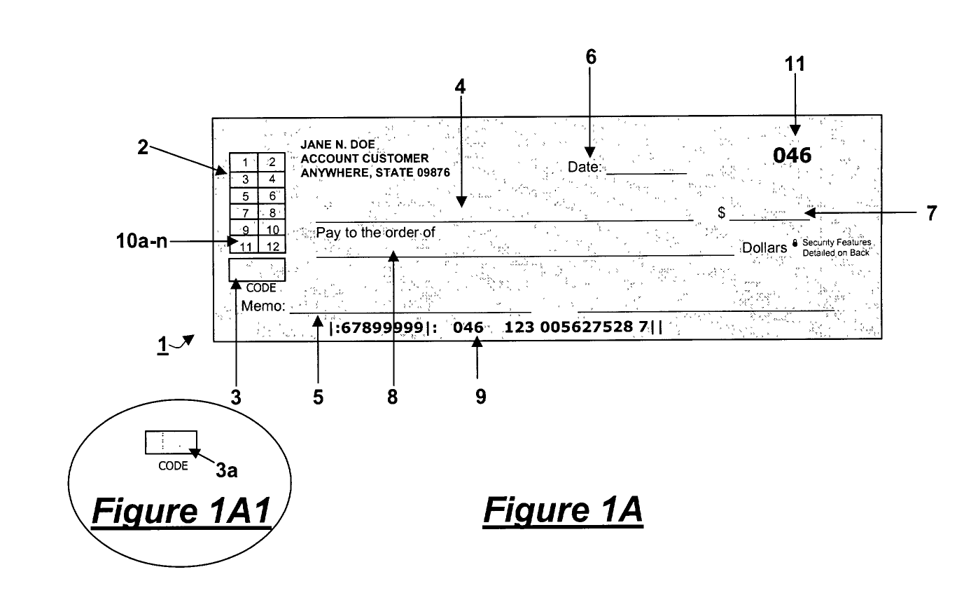

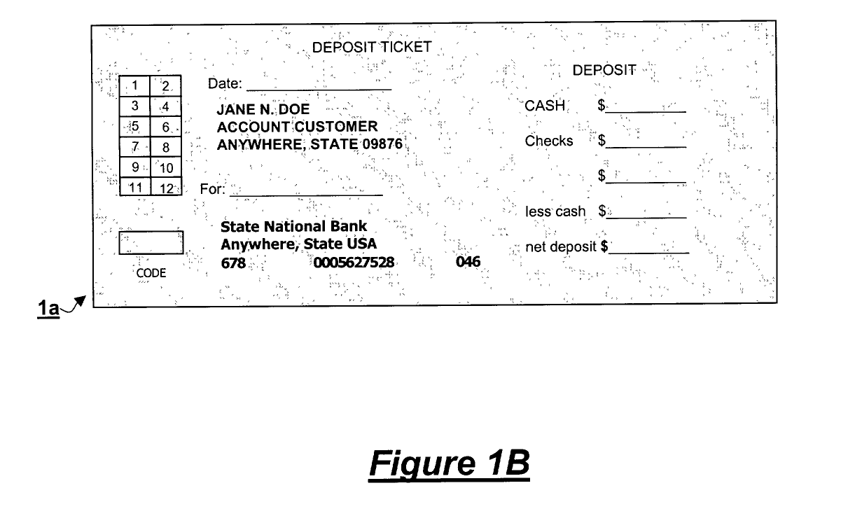

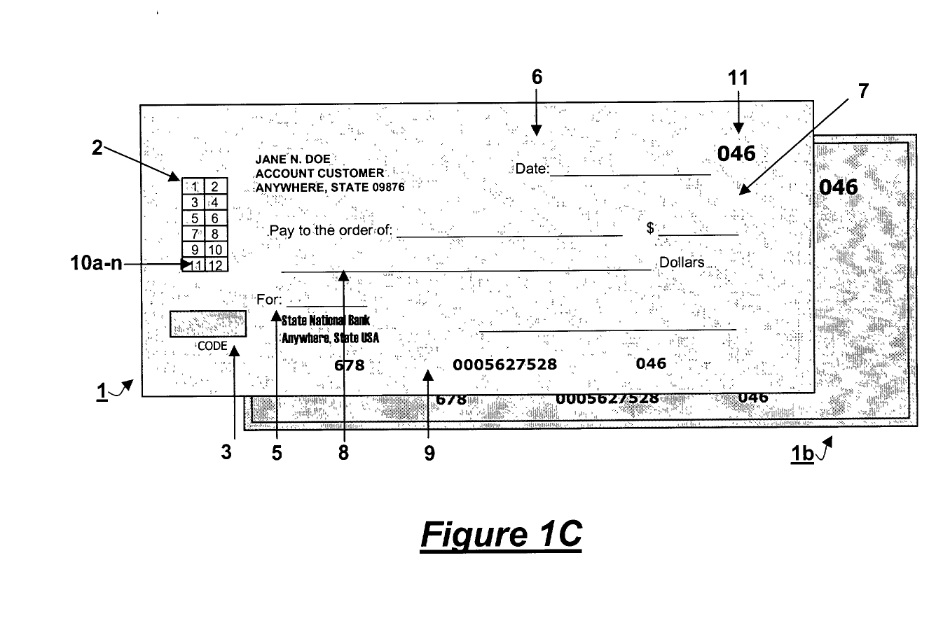

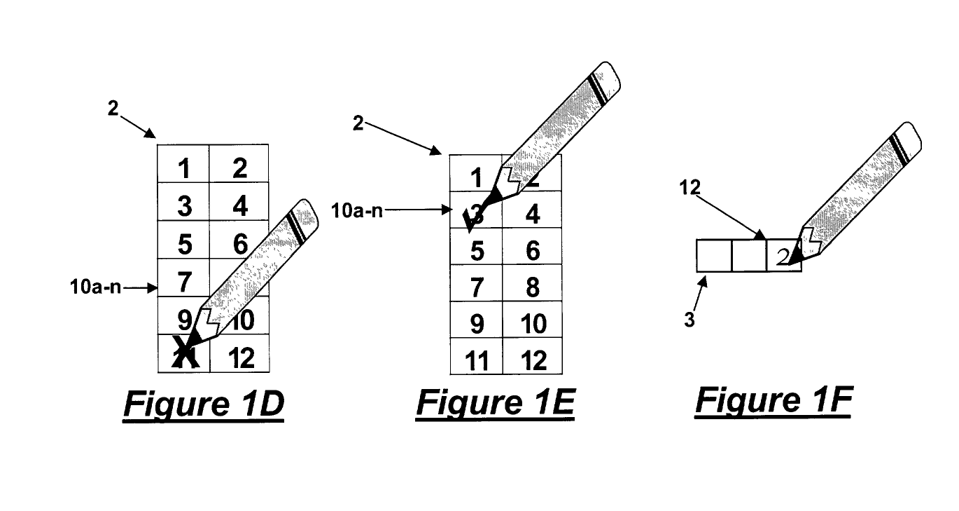

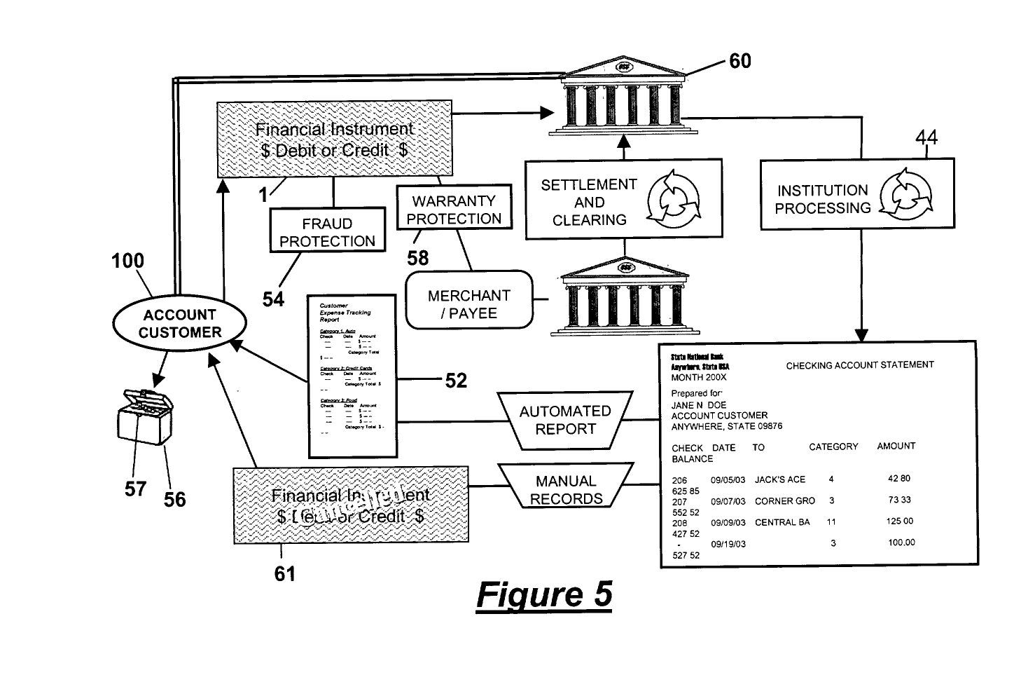

FIG. 1A shows a paper financial instrument 1, with a code bar 2 with indicia 10a-n, such as numbers one (1) through twelve (12) used for manual record-keeping, although the invention also employs letters or other symbols or characters and is not limited to twelve codes; a one, two or three number/letter/symbol/character string code area 3 used in conjunction with the automated record-keeping system; a location on the instrument where the user identifies the payee 4, the image of which may be scanned and transferred to a report 52 (See FIG. 5). As partially illustrated in the Figures, the code area may be a box (See FIG. 1A), or other geometric shape, and may further include sub-areas denoted by separate boxes or lines (See FIGS. 1A1 and 3). The “For” line, indicated at 5, represents the location on the instrument where the user identifies the purpose of the expenditure. Any wording may be used on the financial instrument to designate “For” such as “Memo” or “Note.” The information written on the “For” line may also be scanned and transferred as an image to the report 52.

The manual system of record-keeping shown in FIG. 1D and FIG. 1E allows the user 100 (See FIG. 5) of the system for checks and deposits to mark over one of the indicia 10a-n. For example, numbers one (1) through twelve (12) may be included in the code bar 2 located on the check or the deposit slip 1a (shown in FIG. 1B). Optimally, a user 100 would make the mark within the box for that indicia. Extraneous marks may increase the margin of error in determining the designated category.

In an automated embodiment of the invention as shown in FIG. 1F, the invention provides a method for detecting the presence or absence of a mark 12 placed in the code area 3 on the check 1 and/or deposit 1a.

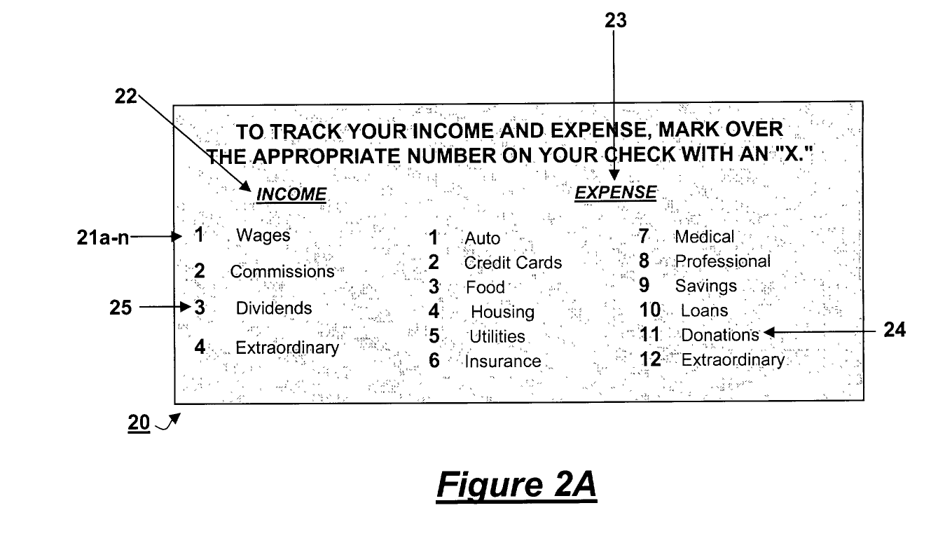

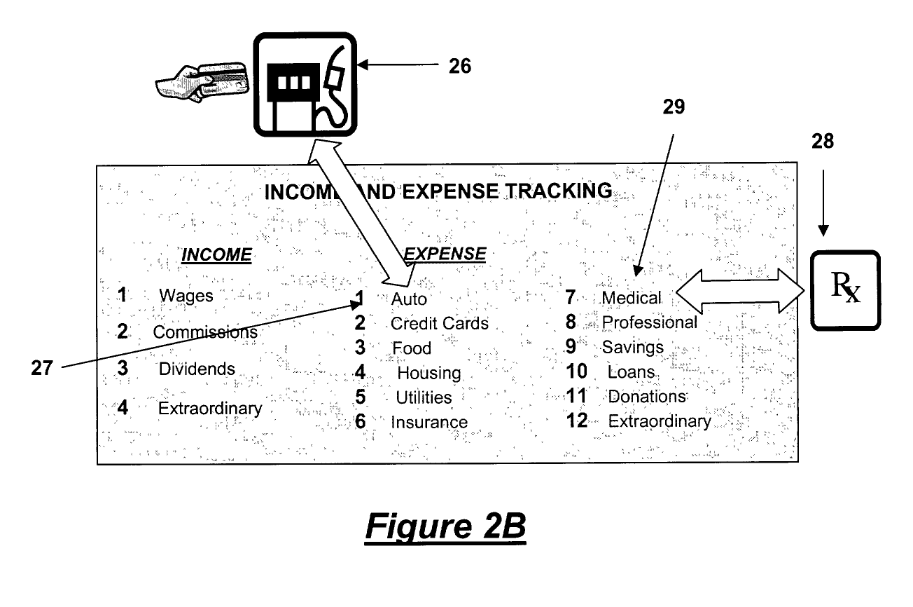

In a manual embodiment, as shown in FIG. 2A, the indicia 10a-n or mark 12 represents an expense 23 or income 22 category. A category code list 20, or chart of accounts, is either pre-determined by the account provider or determined by the account user 100 according to personal preferences, such as shown in the categories and accompanying instructions in FIG. 2A. Changes to the chart of accounts may be made at any time.

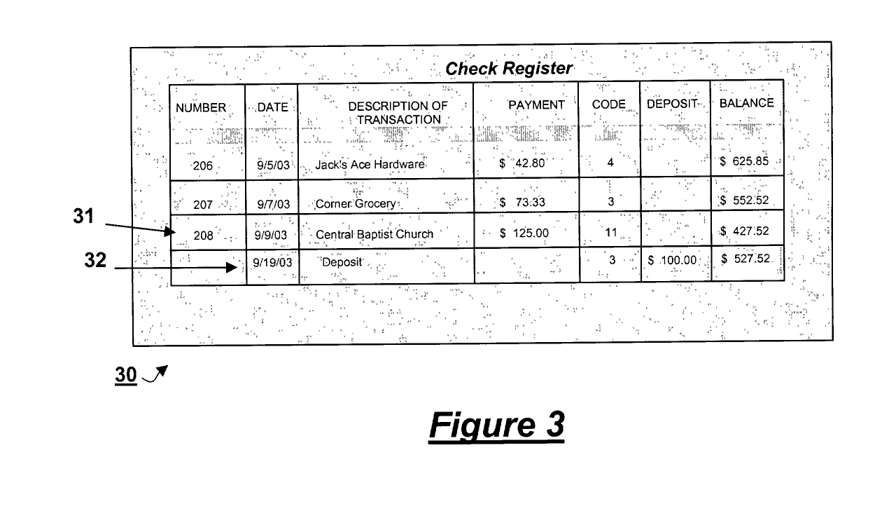

As an example of use of the manual embodiment, a user 100 writing a check 1 for a donation, would mark over the number “11” (as shown in FIG. 1D) if he were using the predetermined category code chart of accounts 20 shown in FIG. 2A to represent a “donation” 24. When entering the check 1 information in the check register 30 (FIG. 3), the user 100 would indicate that code number “11” was marked, with reference to check number 208 (at 31).

For an example using a deposit slip, the user 100 marks over the number “3” box (as shown in FIG. 1E) to record a “dividend” 25 if he were using the suggested chart of accounts 20 shown in FIG. 2A. When entering the information in the check register 30 (FIG. 3), the user 100 would indicate that code number “3” was marked on the deposit slip 1a, with reference to the entry on Mar. 19, 2003 (at 32).

In another embodiment of the invention, the system employs the use of a patent pending check (patent application No. 29/149,095), which contains at least two unique and separate areas or fields for record-keeping information in addition to the industry standard allocated space for date, payee, numeric dollar amount, written dollar amount, signature, “For” (or “Note” or “Memo”) line and industry standard MICR line information. The user may select one of these fields to note record-keeping information.

If done manually, the user in the preferred embodiment, marks over one of the numbers (or letters or symbols or characters) labeled one through twelve on the double column bar on the left side of the patent pending check and/or deposit. If the user elects the automated system, he writes an alphanumeric or other symbol or character in an area located below the double column bar on the check or deposit slip. Marking the code on the double bar or writing the code in a designated area can be accomplished at the same time that additional check or deposit information is being entered.

Another embodiment of the invention, shown in FIG. 1C, provides the user 100 with a unique check 1 and duplicate 1b to record the code manually marked on the bar 2 or in the area 3. The duplicate check 1b may be selected if the financial institution truncates (does not return) the original instrument 1, 1a.

FIG. 2A shows a category code identification card 20 of the invention, which may have an adhesive back to be added to the user's 100 checkbook. The card 20 can be pre-printed to identify predetermined categories, or blank, allowing the user 100 to list personal code numbers 21a-n corresponding to the indicia 10a-n. Predetermined and blank category identifications are applicable to the generic income 22 or expense 23 category listings. The category identification card 20 may be used for either the manual or automated version of the system. FIG. 2A lists a set number of categories for illustrative purposes. The number of categories is not limited.

FIG. 2B shows the category card 20 as used in the electronic form of the invention to register, store and report non-paper check transactions. The electronic instrument may include electronic fields similar to the fields on the paper instrument, and also may include additional categories. In the case of a transaction being initiated with a non-check instrument, such as a debit or credit card, the electronic transaction (See FIG. 5) would include identifying information referencing the name and location of the originating reader. A code, such as one used by the U.S. Standard Industrial Classification (SIC) system, may be used to determine the classification of the merchant or point of sale. As shown in FIG. 2B, a transaction originating at a gas station 26 could be globally “mapped” such that all transactions linked to the system originating from that gas station ID number are classified as being an “Auto” expense 27 on a user's report 52.

Alternatively, the electronic version of the system allows users to designate specific expense or income codes for a particular merchant ID. For example, a user may designate electronic transaction expenses generated at a specified pharmacy terminal 28 as “Medical” 29.

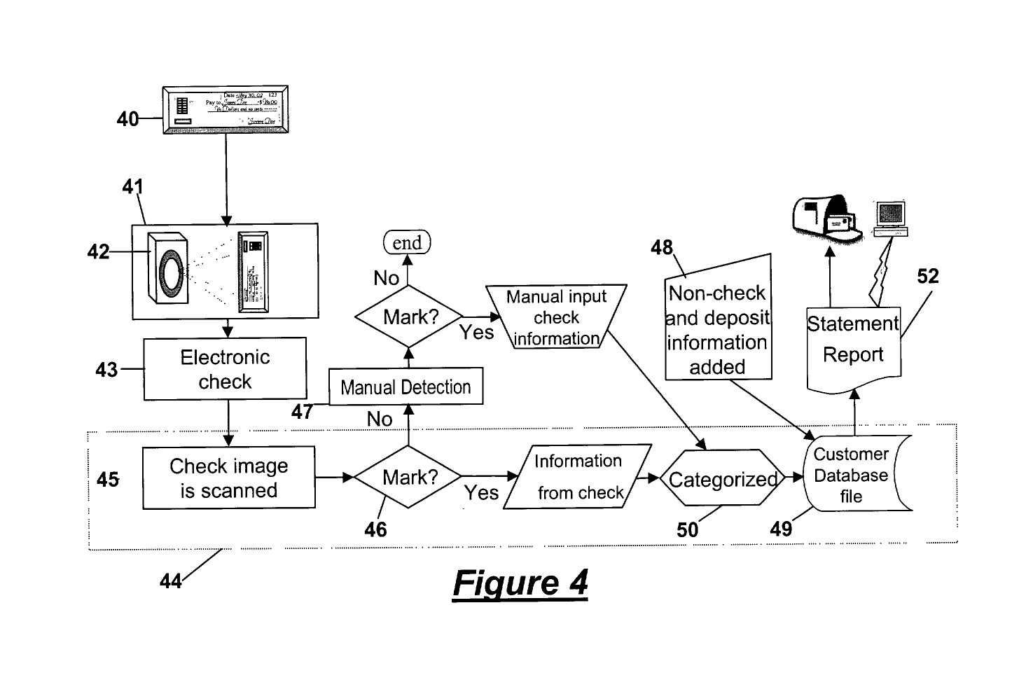

As shown in FIG. 4, a completed paper financial instrument 1, 1a designating an indicia 10a-n, 3 is scanned by a high-speed reader-sorter 41 fitted with special cameras 42, which are now used by all major check imaging software and hardware providers. The image 43 of the check 1 and/or deposit 1a is electronically transferred to the system 44. The image 43 is then scanned by the software of the system 44. By counting the pixels within the code box 3 area, the software system 44 will determine the presence or absence of a mark 12 placed by the user 100. The presence/absence criteria 46 defining the number of pixels can be set by the bank, financial institution or processing center 60 to obtain the desired results, permitting the software to ignore unread boxes 3. Such optical sensing systems detect marked indicia on checks utilizing measurements of proportional dark space within a predetermined grid area defined by a box on a check 1 and/or deposit 1a.

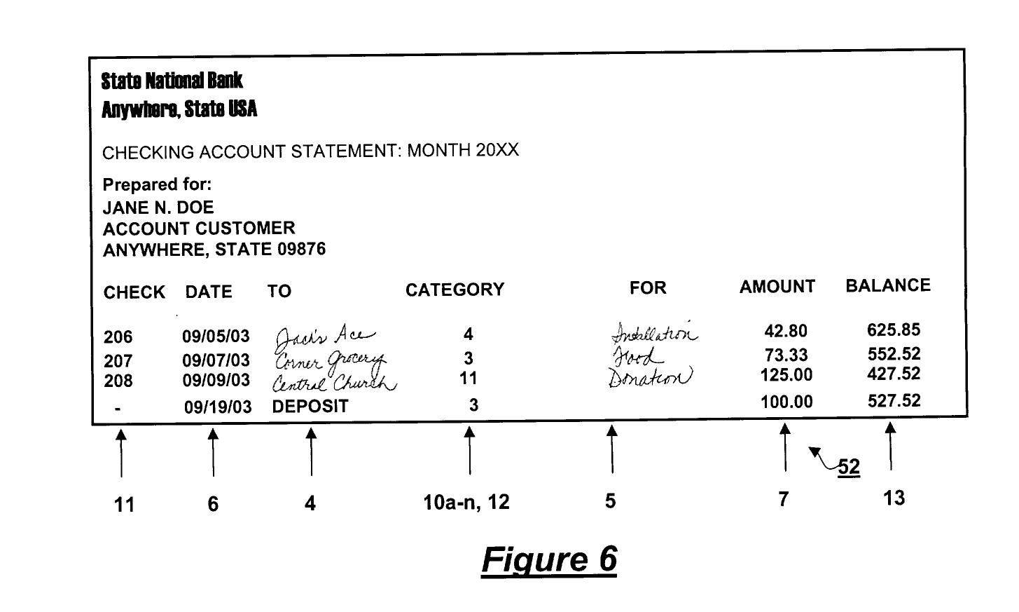

As shown in FIG. 6, the invention provides for transferring a snippet or other transfer of the pixel image of the payee 4 and/or the “For” (“Note” or “Memo”) 5 information and or the date 6 on the check 1 and/or deposit 1a to a report 52 in addition to the transaction number 11, date 6, code number 10a-n, 12, an amount 7, and a balance 13. The user 100 can then see in his/her own handwriting or typing the actual payee 4, date 6, and/or “For” 5 information on the report of income and expense 52. This is useful in situations where the date written on the date line of the instrument is different from the process date of the instrument, which may appear on a report.

In another embodiment (Refer to FIGS. 4, 5, and 6), the invention provides a system to accumulate a date 6, check/item number 11, payee 4, code number 10a-n, 12, amount 7 and “For” information 5 from one or more check 1 and deposit 1a, or the images of those checks and deposits, and to store 49 and categorize 50 that information to make it available to the user 100 through periodic statements of income and expense 52, either in printed form, or in electronic form through e-mail, or through the Internet site of the providing bank, broker, other financial institution or processing center 60.

In another embodiment, the invention provides means for entering non-check income and expense information 48 that affects the checking account, share draft account, or transaction account. This information could come from credit cards, debit cards, automatic debits cleared through the ACH (automated clearing house), or transactions generated by the financial institution, such as interest payments (income) or service or check charges (expense). These transactions are electronically identified and linked to a predetermined or self-determined category.

FIG. 5 shows another embodiment of the invention that provides a system of fraud protection 54 to the user 100 of the checks 1. Protection is provided to the user 100 of the account against these checks 1 being stolen and used in an unauthorized manner. When the checks 1 are produced, they are identified or labeled as having fraud protection, and are recorded in a database at a given facility, such as Rec-Chek or a check production facility. They are recorded by check number, account number, date of production, and address used in shipping. Only those recorded checks will be protected against fraud and only while the user 100 is a member in good standing of the certain type of checking or draft account offered by the sponsoring institution, and for a given period of time.

The preferred embodiment of the system provides a financial instrument 1 with a code bar 2 with numbers 10a-n one through twelve used for manual record-keeping; a one, two or three number/letter/symbol/character code area 3 used for automated record-keeping system; a field for the payee 4, the image of which may be scanned and transferred to the account supplier's reports 52; a field for the “For” line 5, the image of what is written on the “For” line 5 may also be scanned and transferred to the account supplier's reports 52; and a field for the “date” line 6, the image of what is written on the “date” line 6 may also be scanned and transferred to the account supplier's reports 52.

The preferred manual system of record-keeping allows the user 100 of the unique and patent pending check and deposit to mark over one of the numbers, one through twelve, on the bar 2 located to the left side of the check and the deposit representing an expense 23 or income 22 category. The category list 21a-n, or chart of accounts, is either pre-suggested by the account supplier and/or the bank or other financial institution 60, or any number 10a-n can be changed by the user 100 to represent any category 21a-n of income 22 or expense 23. The manual system creates information for the user 100. The code numbers 10a-n are not used by the bank, other financial institution, or processing center 60 for any purpose.

If the user 100 is banking with a financial institution 60 that truncates (does not return) checks, the user 100 may elect to code and retain the duplicate copies of the checks 1 and/or deposits 1a written, and utilize these copies as the source of record-keeping information. The duplicate copies of the checks and deposits have the same number one through twelve (or letters or symbols or characters; the number of codes is not limited to 12) code bar as the original checks and deposits.

As shown in FIG. 5, the preferred embodiment includes a check file box 56 provided, for example by the user's 100 financial institution 60, to store the returned and cancelled checks 61. Dividers 57 numbered one through twelve (or using letters, characters, or symbols) (This is an example only, the dividers are not limited to twelve and may be any arbitrary number found to be useful.) can be used to store the cancelled checks 61, by number 11 and by category 21 an, so that at the end of the year, the user 100 has all income 22 and expense 23 cancelled checks and deposits 61 sorted by category 21a-n for the whole year.

In the preferred embodiment, as shown in FIG. 1D and FIG. 1E, when the user 100 writes a check 1 or a deposit 1a, he simply marks over one of the numbers 10a-n one through twelve (in the example), to represent one of the income 22 or expense 23 categories. For example, if the user 100 writes a check for the weekly church donation, he would mark over the number “11” box if he were using the suggested chart of accounts 20 shown in FIG. 2A. When entering the check information in the check register (FIG. 3), the user 100 would indicate that the corresponding code number “11” was marked (See FIG. 3, check number 208 at 31).

If the check 1 or deposit 1a is truncated (not returned to the user 100) by the financial institution 60, copies of the check 1 and/or deposit 1a can be maintained, in addition to marking the code 10a-n in the check register 30.

Regardless of the method chosen by the user 100: marking the checks 1 and deposits 1a and filing them in the check file box 56 when returned; marking the check register 30; or marking the duplicate copies 1b of the transactions, the user 100 has a categorization of expenses 23 and income 22, making income tax preparation and budgeting easier.

The automated version of the system utilizes software to produce periodic reports 52 of income and expense, according to an alpha/numeric/symbol/character in the area 3. In the preferred embodiment, the area 3 is a box located on special patent pending checks 1 and deposits 1a. In the electronic version, the alpha/numeric/symbol/character is data included in the information of the instrument.

Reports 52 may not necessarily be separate reports but may be information supplied in an existing report, such as a broker's monthly statement. Reports 52 may also include more than one account associated with a user 100.

As shown in FIG. 4, the account supplier's software 44 is programmed to detect, capture, and interpret the alpha/numeric/symbol/character 12 (or if not able to interpret, to pass the image of the check to a workstation for operator viewing 47). In addition, non-check and deposit financial information 48 is captured, adding credit card, debit card, and automatic debit and credit information to the information stored in a database 49. The information will then be reported to the user 100, periodically, such as monthly, quarterly, semi-annually or annually, by the financial institution offering the service 60.

Information is gathered at separate points and from separate sources. First, standard Proof of Deposit systems gather information from the checks and deposits at the first point of entry into the clearing system. From the industry standard MICR line at the bottom of the check and deposit (magnetic ink character recognition), the ABA Routing and Transit number, the user account number, the item number (check or deposit number), process date, and the amount (the amount may be scanned and encoded at the first point of capture) are read by conventional proof of deposit accounting systems. To this information, a scanned image of each check and deposit may also be made at several points in the clearing process. The combination of the MICR and imaged information is used as basic input into the account supplier's system.

In the preferred embodiment, the check 1 and deposit 1a is scanned 41. The scan 41 process may incorporate an indicator to identify instruments as instruments to be scanned by the system 44 of the present invention, or the system 44 may perform a “presence/absence” scan of the area 3, determining if any mark 12 was made. If no mark 12 appears in the are 3, the instrument 1, 1a is recorded as “un-marked” and reported as such, or ignored. If a mark 12 is detected, the software 44 utilizes the character recognition software utility and attempts to recognize or interpret the mark as one or more than one number and/or letter. Standard character recognition software is used. An operator can “tune” the software for the desired reliability of recognition, which is more reliable than recognition by a human operator.

The technology used in character recognition has advanced since the adoption of check and document imaging. More and more financial institutions will offer check and statement imaging, and more items will be truncated at their first point of entry into the clearing process. The images of these documents, both front and back, will be transmitted. Character recognition will facilitate faster, more economical and more accurate processing of the images. Companies such as Orbograph, Mitek, Parascript and A21A provide both ICR (Intelligent Character Recognition) and OCR (Optical Character Recognition) functions in their proprietary software systems. The account supplier may enter into a license relationship with one or more of such firms to add their recognition features to the system.

The software provides two levels of character recognition. First, existing CAR (Courtesy Amount Read) software, which is used to recognize the numeric amount of the check and deposit, will be used to recognize the alphanumeric/symbol/character placed in the area on the check or deposit. Existing character recognition software incorporates neural network technology to recognize and convert hand printed numeric characters into digital data.

The character recognition assigns confidence levels to the recognized characters. Those confidence levels, at the operator's discretion, are then used to determine if the assigned digital data should be accepted and passed on to the account supplier's software, or forwarded to a human workstation operator for further analysis.

The second level of character recognition involves characters from both the handwritten payee line and/or the “Memo” or “For” or “Date” line on the checks. The software will first capture a snippet of both the payee, the date, and the “For” line. Present technology allows recognition software to recognize natural handwriting, cursive, printed character, words, numbers, or any combination. The snippet is stored and printed or displayed on the periodic reports, as well as attached as a part of the digital file of each transaction. The character recognition software will then attempt to interpret each letter or character in the description of the payee, date, and/or “For” line. That information could then be reported to the user 100 in the form of reports showing, for example, “Expenses By Payee.”

The system of the invention also provides fraud protection mechanisms 54 for the checks. Each check 1 printed for users 100 of the system (by authorized check printing companies) will be linked to a database containing each customer's name, address, account number, financial institution routing number, and individual sequence number of all checks produced. This database may be maintained by the check printer. Any loss incurred by the user of the account (authorized customer) resulting from lost or stolen checks, whether that loss occurs before the customer receives the checks or not, will be protected and reimbursed by an institution, such as Rec-Chek or the check printer, within a maximum amount limit specified and within a specified time frame. Coverage will apply to the individual check order only, and not any other checks used, or any reproduced copies.

Similarly the system is adaptable to a mechanism that fulfills a need for warranty protection 58 on the check 1. Coverage will be provided to users 100 of the system for purchases made with checks 1 provided with the system. This coverage is similar to coverage provided today by credit card companies for purchases made with their card. The system similarly allows an extension of any standard warranty, if one exists, and adds warranty protection on predetermined items not covered by a manufacturer's warranty protection.

The preferred embodiments herein disclosed are not intended to be exhaustive or to unnecessarily limit the scope of the invention. The preferred embodiments were chosen and described in order to explain the principles of the present invention so that others skilled in the art may practice the invention. Having shown and described preferred embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

I claim:

1. A system for providing multiple reporting and storing options for deposit and expense information designated by a financial instrument linked to a predetermined account maintained on behalf of a depositor payor by a financial institution provider comprising:
(a) a transaction initiating instrument capable of including financial information linked to the account, the instrument including 1) one, or a plurality of indicators in an array, in which an indicia corresponding to one of a plurality of predetermined categories can be designated, 2) a field for entry of an amount of a transaction, 3) a field for entry of a date, 4) a field for entering memo information related to the transaction, 5) a field for identifying at least one payee associated with the transaction, and 6) the depositor payor's account identification information; and
(b) a system for processing the instruments following the clearing and settlement of a funds transfer initiated by the instrument in a transaction, the system being provided by or on behalf of the financial institution provider and, as to each account, having a separate data file uniquely associated with the depositor payor of the account in which, for transactions associated with the instrument, information corresponding to a transaction which is designated by the indicia of the instrument corresponding to a predetermined category is maintained, the system comprising a mechanism for 1) determining a designated indicator within the array which has the indicia applied, 2) linking information associated with the designated indicia to one or more than one of the fields on the instrument and the account information, 3) sorting information derived from the fields based on the predetermined category linked to the designated indicia, 4) collating the information of the sorted fields into one or more than one data record associated with a predetermined category, 5) generating a report uniquely associated with one or more than one account associated with the depositor payor comprising a compilation of the collated information, and 6) making the report generated available to one or more than one recipient selected from the group consisting of the depositor, the payor, and one or more than one pre-designated recipient on behalf of the depositor payor.

2. The system of claim 1 wherein the array is selected from the group consisting of a block of indicia corresponding to categories and at least one receptor for receiving an indicia generated by the depositor payor.

3. The system of claim 2 where the array is a block of integers.

4. The system of claim 3 where the integers are consecutive starting at 1 and ending at 12.

5. The system of claim 2 wherein the array is a blank area divided into three parts and capable of accepting a writing.

6. The system of claim 1 in which the instrument bears fraud protection indicia linking the financial instrument to a reimburser to the depositor payor in the event of fraudulent use.

7. The system of claim 1 wherein warranty protection is provided for purchases made using the instrument.

8. The system of claim 1 in which the predetermined categories are determined by the financial institution provider.

9. The system of claim 1 in which the predetermined categories are determined by the depositor payor.

10. The system of claim 1 in which a physical embodiment of the instrument is truncated and an electronic facsimile of the instrument is maintained in a data file.

11. The system of claim 1 in which the report generated includes an image of one or more than one of the fields on the instrument, the image derived from the facsimile of the instrument maintained in the data file.

12. The system of claim 1 in which the report generated is transmitted electronically.

13. The system of claim 1 in which the report made available includes one or more than one of an alphanumeric visual display and an image.

14. The system of claim 1 wherein collated information is linked to information concerning financial debits against, and credits to, the account associated with one or more than one category of transactions and a payment to, or credit from, the account provider.

15. The system of claim 1 in which the instrument comprises an electronically readable device having stored thereon one or more than one designated indicia, each linked to a predetermined category.

16. The system of claim 15 in which a funds transfer initiated by the instrument in a transaction occurs at an electronic terminal that generates a transaction record of the depositor payor's account identification information and the amount and date of a transaction and a code before transmitting the transaction record to a payment and settlement mechanism.

17. The system of claim 16 in which the code identifies the payee associated with the transaction.

18. The system of claim 17 in which the code identifying the payee associated with the transaction is determined according to the payee's designation in the U.S. Standard Industrial Classification (SIC) system.

19. The system of claim 16 in which the code identifies a type of transaction.
